(19) United States
(12) Patent Application Publication
(10) Pub. No.: US 2006/0173740 A1
(43) Pub. Date: Aug. 3, 2006

(54) Distribution device, distribution method, and distribution program

(75) Inventors: Takami Kashiwabara, Nagoya (JP); Shinya Saka, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/147,429

(22) Filed: Jun. 8, 2005

(30) Foreign Application Priority Data
Feb. 2, 2005 (JP) 2005-025833

(51) Int. Cl. G06Q 30/00

(52) U.S. Cl. 705/14

(57) ABSTRACT

A content distribution server 1 which distributes, to a client, promotion content for prompting a user to execute destination content comprises: a state acquisition section that acquires the states of the client and destination content; a suitability calculation section 21 that calculates the suitability of the destination content in the client based on the states of the client and destination content; a content order determination section 22 that determines the order of the promotion content based on the suitability; and a content distribution section 23 that distributes the promotion content to the client according to the order of the promotion content.

### BACKGROUND OF THE INVENTION

1. Field of the Invention

The present invention related to a distribution device which distributes second data for prompting a user to utilize first data, to a device and, more particularly, to a distribution device, distribution method, and distribution program which distribute, for example, promotion content for prompting the user to utilize destination content, to a client.

2. Description of the Related Art

In a facility such as an amusement arcade, a plurality of clients available to unspecified users are provided. An object of the clients is to allow the users to enjoy content for charging purpose or the like. The content that the users utilize is referred to as destination content, here. When not being operated by the user, the client presents the destination content that it can provide, as well as executes the promotion content for prompting the user to utilize the destination content. Assuming that the destination content is a video game, the promotion content is a demonstration of the video game. Assuming that the destination content is a movie, the promotion content is a movie preview. When determining that the user utilizes the destination content corresponding to promotion content that the client has presented to the user, the client executes the destination content.

In the case where the clients are connected to a server through a network, the server distributes destination content according to requests of respective clients.

As a conventional art related to the present invention, Jpn. Pat. Appln. Laid-Open Publication No. 2004-40484 (pages 3 to 6, FIG. 1) described below is known, for example. The content distribution system according to the above conventional art creates a program listing for each user based on the content use condition corresponding to the user's taste and content information and distributes the program listing.

However, even if the promotion content is not a suitable one (for example, the promotion content fails to meet the requirements of uses) in the conventional client, the promotion content remains to be executed, decreasing the utilization rate of destination content in the client.

### SUMMARY OF THE INVENTION

The present invention has been made to solve the above problem, and an object thereof is to provide a distribution device, a distribution method, and a distribution program capable of distributing suitable promotion content to a device such as a client.

To solve the above problem, according to a first aspect of the present invention, there is provided a distribution device (content distribution server) which distributes, to a device (client), second data (second content) for prompting a user to utilize (execute) first data (first content) comprising: a state acquisition section that acquires the states of the device (client) and first data (first content); a suitability calculation section (content suitability calculation section) that calculates the suitability of the first data (content) in the device (client) based on the states of the device (client) and first data (content) that have been acquired by the state acquisition section; an order determination section (content order determination section) that determines the order of the second data (content) based on the suitability that has been calculated by the suitability calculation section (content suitability calculation section); and a distribution section (content distribution section) that distributes the second data (content) to the device (client) according to the order of the second data (content) that has been determined by the order determination section (content order determination section).

In the distribution device according to the present invention, the suitability calculation section (content suitability calculation section) has a predetermined scoring setting related to the states of the device (client) and first data (first content) and calculates the suitability of the first data (first content) based on the predetermined scoring setting.

In the distribution device according to the present invention, the order determination section determines the order of the second data according to d'Hondt system using the suitability.

In the distribution device according to the present invention, the state of the device (client) includes any of information related to location condition of the device, weather, and date and hour.

In the distribution device according to the present invention, the state of the first data (first content) includes any of information related to target user of the first data (first content), recommendation of the first data, (first content) and execution state of the first data (first content).

According to a second aspect of the present invention, there is provided a distribution method (content distribution method) for distributing, to a device (client), second data (second content) for prompting a user to utilize (execute) first data (first content) comprising: a state acquisition step that acquires the states of the device (client) and first data (first content); a suitability calculation step (content suitability calculation step) that calculates the suitability of the first data (first content) in the device (client) based on the states of the device (client) and first data (first content) that have been acquired by the state acquisition step; an order determination step (content order determination step) that determines the order of the second data (second content) based on the suitability that has been calculated by the suitability calculation step (content suitability calculation step); and a distribution step (content distribution step) that distributes the second data (second content) to the device (client) according to the order of the second data (second content) that has been determined by the order determination step (content order determination step).

In the distribution method (content distribution method) according to the present invention, the suitability calculation step (content suitability calculation step) has a predetermined scoring setting related to the states of the device (client) and first data (first content) and calculates the suitability of the first data (first content) based on the predetermined scoring setting.

In the distribution method (content distribution method) according to the present invention, the order determination step (content order determination step) determines the order of the second data (second content) according to d'Hondt system using the suitability.

In the distribution method (content distribution method) according to the present invention, the state of the device (client) includes any of information related to location condition of the device (client), weather, and date and hour.

In the distribution method (content distribution method) according to the present invention, the state of the first data (first content) includes any of information related to target user of the first data (first content), recommendation of the first data (first content), and execution state of the first data (first content).

According to a third aspect of the present invention, there is provided a distribution program (content distribution program) which allows a computer to execute a distribution method (content distribution method) for distributing, to a device (client), second data (second content) for prompting a user to utilize (execute) first data (first content) comprising: a state acquisition step that acquires the states of the device (client) and first data (first content); a suitability calculation step (content suitability calculation step) that calculates the suitability of the first data (first content) in the device (client) based on the states of the device (client) and first data (first content) that have been acquired by the state acquisition step; an order determination step (content order determination step) that determines the order of the second data (second content) based on the suitability that has been calculated by the suitability calculation step (content suitability calculation step); and a distribution step (content distribution step) that distributes the second data (second content) to the device (client) according to the order of the second data (second content) that has been determined by the order determination step (content order determination step).

In the distribution program (content distribution program) according to the present invention, the suitability calculation step (content suitability calculation step) has a predetermined scoring setting related to the states of the device (client) and first data (first content) and calculates the suitability of the first data (first content) based on the predetermined scoring setting.

In the distribution program (content distribution program) according to the present invention, the order determination step (content order determination step) determines the order of the second data (second content) according to d'Hondt system using the suitability.

In the distribution program (content distribution program) according to the present invention, the state of the device (client) includes any of information related to location condition of the device (client), weather, and date and hour.

In the distribution program (content distribution program) according to the present invention, the state of the first data (first content) includes any of information related to target user of the first data (first content), recommendation of the first data (first content), and execution state of the first data (first content).

According to the present invention, it is possible to make an appeal to users through an effective distribution of, e.g., promotion content, thereby increasing the availability of destination content in a client.

### BRIEF DESCRIPTION OF THE DRAWINGS

FIG. 1 is a block diagram showing an example of the configuration of a demo content distribution server according to the present invention;

FIG. 2 is a table showing an example of a classification setting according to the present invention;

FIG. 3 is a table showing an example of a scoring setting based on location condition and installation condition according to the present invention;

FIG. 4 is a table showing an example of a scoring setting based on weather and date and hour according to the present invention;

FIG. 5 is a table showing an example of a scoring setting based on recommendation according to the present invention;

FIG. 6 is a table showing an example of a scoring setting based on an execution state according to the present invention;

FIG. 7 is a table showing an example of a distribution setting according to the present invention;

FIG. 8 is a table showing an example of a position setting according to the present invention;

FIG. 9 is a table showing an example of a content setting according to the present invention;

FIG. 10 is a flowchart showing an example of the operation of the demo content distribution server in its running condition according to the present invention;

FIG. 11 is a table showing an example of a client state according to the present invention;

FIG. 12 is a table showing an example of an execution state according to the present invention;

FIG. 13 is an example of a suitability calculation table according to the present invention;

FIG. 14 is an example of a content order determination table according to the present invention; and

FIG. 15 is a flowchart showing an example of a content distribution operation according to the present invention.

### DETAILED DESCRIPTION OF THE PREFERRED EMBODIMENTS

An embodiment of the present invention will be described below with reference to the accompanying drawings.

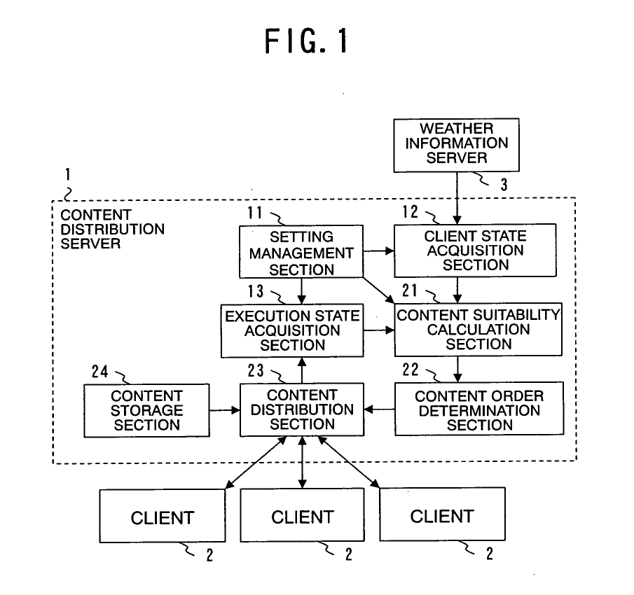

Firstly, the configuration of a demo content distribution server, which is a distribution device according to the present invention, will be described. FIG. 1 is a block diagram showing an example of the configuration of the demo content distribution server according to the present invention. A demo content distribution server 1 includes a setting management section 11, a client state acquisition section (state acquisition section) 12, an execution state acquisition section (state acquisition section) 13, a content suitability calculation section (suitability calculation section) 21, a content order determination section (order determination section) 22, a content distribution section (distribution section) 23, and a content storage section 24. The content distribution section 23 is connected to an external client 2. The client state acquisition section 12 is connected to an external weather information server 3.

The content storage section 24 previously stores destination content (first data) and promotion content (second data) for prompting the execution of the destination content.

Next, the operation of the content distribution server 1 according to the present invention will be described.

Firstly, various settings made on the content distribution server 1 before the time of operation thereof will be described.

A manager of the content distribution server 1 previously inputs a suitability calculation setting to the content distribution server 1. The term “suitability” used here indicates how certain destination content is appropriate in a certain client 2 and is represented by the total points that have been scored with respect to various items. The setting management section 11 acquires the suitability calculation setting from the data input by the manager and transmits it to the content suitability calculation section 21. The content calculation setting includes a classification setting, a scoring setting, a distribution setting, a position setting, and a content setting.

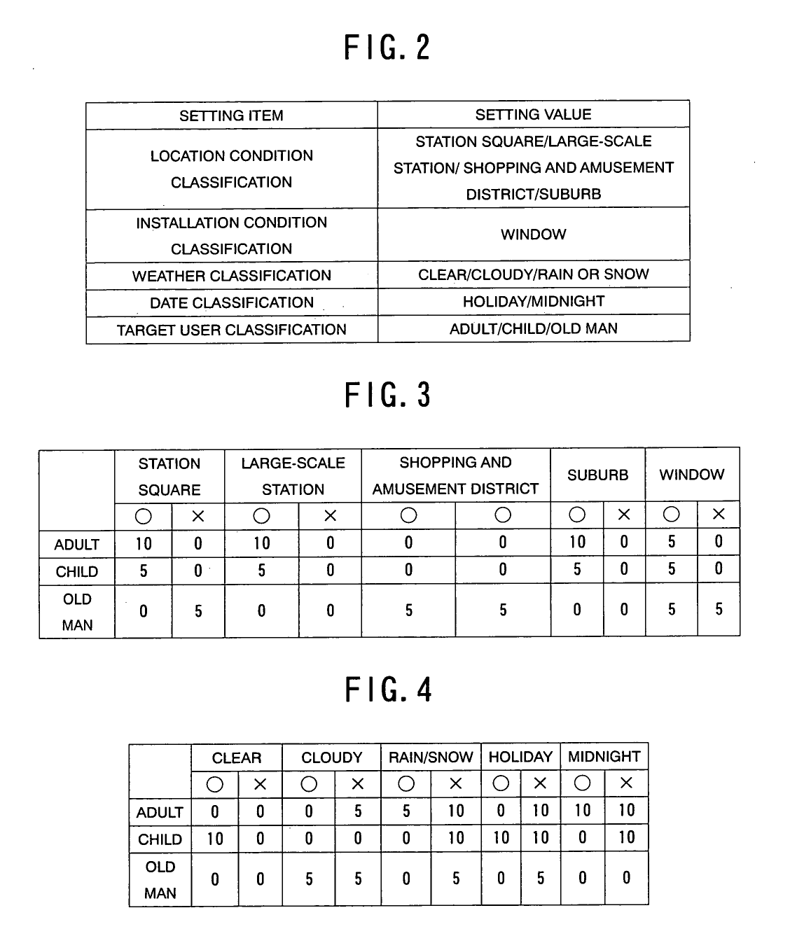

FIG. 2 is a table showing an example of a classification setting according to the present invention. The classification setting includes the following setting items: location condition, installation condition, weather, date and hour, and target user. Location condition classification is the classification of the location condition for which scoring is made and includes station square, large-scale station, shopping and amusement district, and suburb. Installation condition classification is the classification of the installation condition for which scoring is made and includes Window. Weather classification is the classification of the weather for which scoring is made and includes clear, cloudy, and rain/snow. Date and hour classification is the classification of the date and hour condition for which scoring is made and includes holiday and midnight. Target user classification is the classification of the user targeted for the content and includes adult, child, and old man.

FIG. 3 is a table showing an example of a scoring setting based on location condition and installation condition according to the present invention. In the table, points to be added are set for respective target users depending on whether Location condition and Installation condition of the client 2 match (∘) or mismatch (×) with location condition classification and installation classification, respectively. FIG. 4 is a table showing an example of a scoring setting based on weather and date and hour according to the present invention. Similarly, points to be added are set for respective target users depending on whether weather and date and hour of the client 2 match (∘) or mismatch (×) with weather classification and date and hour classification, respectively. Although the above a scoring setting for location condition, installation condition, weather, and date and hour, are made in both match and mismatch cases, the scoring setting may be made in one of match and mismatch cases.

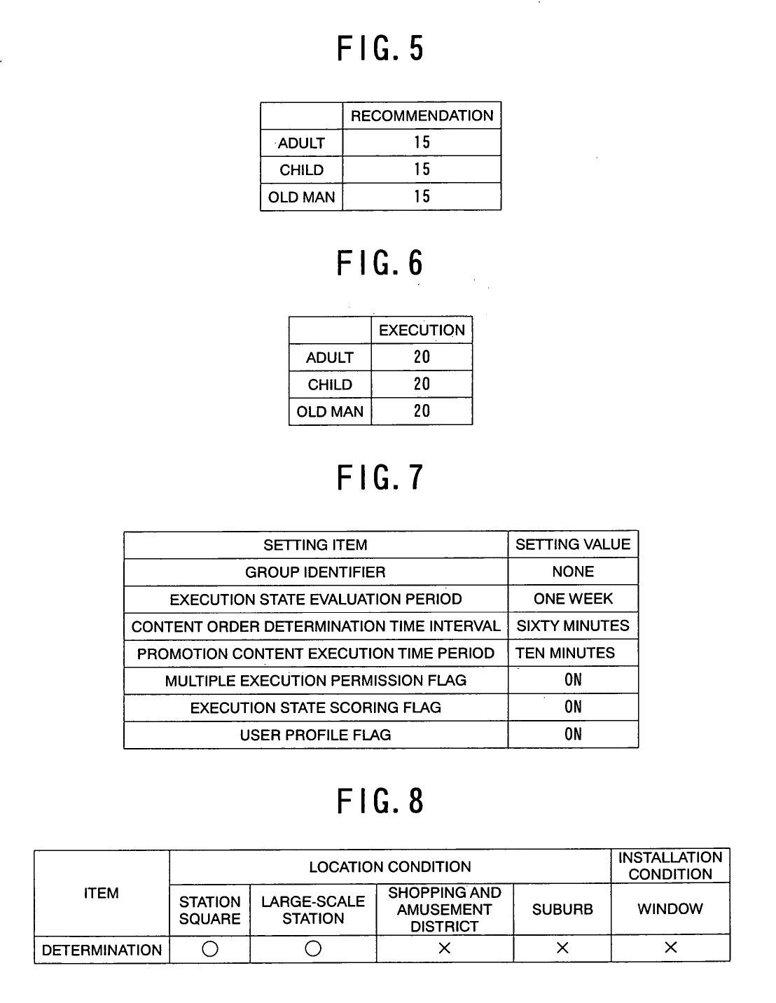

FIG. 5 is a table showing an example of a scoring setting based on recommendation according to the present invention. In this table, points to be added in the case where the manager has designated certain content as recommendation content are set for respective target users. FIG. 6 is a table showing an example of a scoring setting based on an execution state according to the present invention. In this table, points to be added in the case where the destination content is executed through the promotion content in the client 2 are set for respective target users.

FIG. 7 is a table showing an example of a distribution setting according to the present invention. The setting item of the distribution setting includes group identifier, execution state evaluation period, content order determination time interval, promotion content execution time period, multiple execution permission flag, execution state scoring flag, and user profile flag.

Group identifier is an identifier that indicates a client group to which the client 2 belongs. The identifier is not set for the client 2 that is not subject to grouping, so that the one client 2 constitutes one client group. Execution state evaluation period indicates the period during which the previous execution state of destination content is evaluated and the period is brought to bear on the suitability calculation. Content order determination time interval indicates the time interval at which determination of content order is made. Promotion content execution time period indicates the time period during which one promotion content is executed. Multiple execution permission flag indicates whether one promotion content is executed more than once or not. In the case where Multiple execution permission flag is On, an “executed” flag is set to On, so that the promotion content is not executed afterward. Execution state scoring flag indicates whether points are added or not when destination content is executed while corresponding promotion content is being executed. When execution state scoring flag is On, points are scored depending on the execution state. User profile flag indicates whether input of the user profile is permitted or not. When user profile flag is On, an authentication procedure by inputting the user profile is required in the client 2.

Setting values are set for respective setting items as described below. group identifier: none, execution state evaluation period: one week, suitability calculation time interval: 60 minutes, promotion content execution time period: 10 minutes, multiple execution permission flag: On, execution state scoring flag: On, user profile flag: On.

FIG. 8 is a table showing an example of a position setting according to the present invention. The setting item of the position setting includes the above respective classifications related to location condition classification and installation condition classification. Whether location condition and installation condition of the client 2 matches or mismatches is set for all the classifications. In this example, the condition of the client 2 matches with the station square and large-scale station classifications.

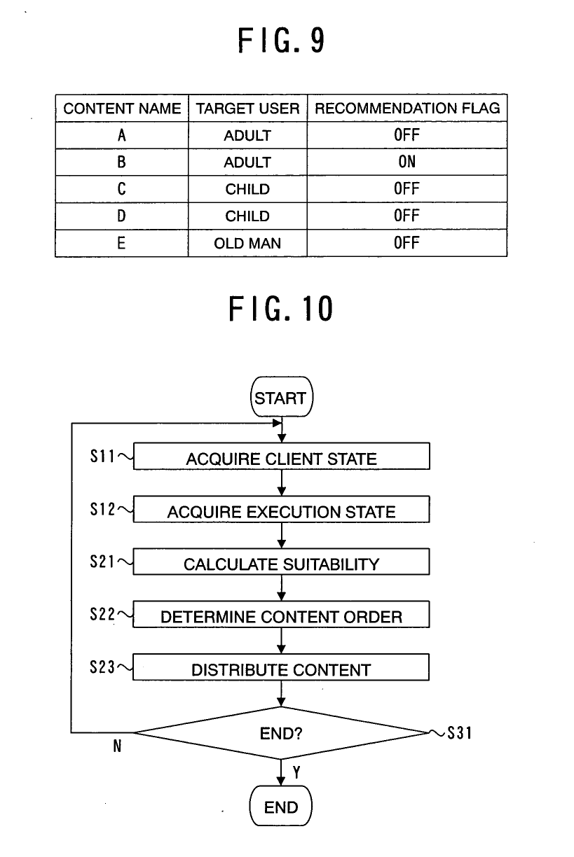

FIG. 9 is a table showing an example of a content setting according to the present invention. The setting item of the content setting includes target user and recommendation flag, which are set for respective contents. Target user is selected from the abovementioned target user classification. Recommendation flag indicates whether points are added in order to preferentially execute recommended promotion content. In this example, target user is set to adult, adult, child, child, old man, and recommendation flag is set to Off, On, Off, Off, Off, with respect to contents A, B, C, D, and E, respectively.

The manager selects only necessary items from respective items of the suitability calculation setting. The respective items of the suitability calculation setting need not be exclusive conditions.

An operation of the content distribution server 1 in its running condition will next be described.

FIG. 10 is a flowchart showing an example of the operation of the demo content distribution server in its running condition. Firstly, the client state that has been acquired by the client state acquisition section 12 is output to the content suitability calculation section 21 (S11). The execution state that has been acquired by the execution state acquisition section 13 is output to the content suitability calculation section 21 (S12). The content suitability calculation section 21 uses a suitability calculation table and client state to calculate the suitability of each content in each client 2 and transmits the obtained calculation result to the content order determination section 22 (S21). The content order determination section 22 determines the content order and transmits the determined content order to the content distribution section 23 (S22). The content distribution section 23 distributes promotion contents previously stored in the content storage section 24 according to the determined content order (S23). The content distribution section 23 then determines whether to end or not the current flow (S31). When it is determined that the flow is not ended (No in S31), the flow returns to the step S11; on the other hand, when it is determined that the flow is ended (Yes in S31), the current flow is ended.

The client 2 executes the promotion content that has been distributed from the content distribution server 1. When a user requests destination content while the corresponding promotion content is being executed by the client 2, the client 2 requests the content distribution server 1 to distribute the destination content and executes the destination content that has been distributed from the content distribution server 1.

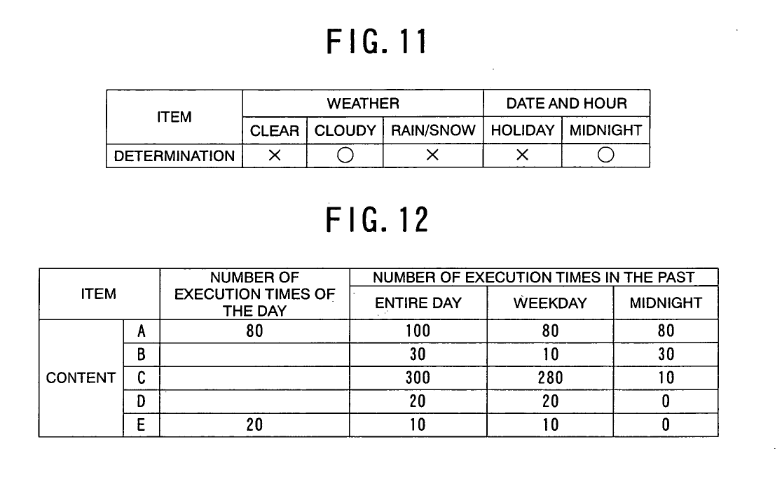

A description will next be given of a client state acquisition process. The client state acquisition section 12 acquires weather and date and hour as the client state. The client state acquisition section 12 acquires information related to weather from the external weather information server 3 and information related to date and hour from an internal or external clock function. Further, the client state acquisition section 12 makes determination for the acquired weather and date and hour according to weather classification and date and hour classification, and output the determination result to the content suitability calculation section 21. FIG. 11 is a table showing an example of a client state according to the present invention. In this example, determinations are made such that weather is cloudy and date and hour is midnight of weekday.

Next, a description will be given of an execution state acquisition process. The execution state is the number of times that the destination content has been executed on the day and the number of times that the destination content has been executed during the previous execution state evaluation period. When an execution state flag is On, the execution state acquisition section 13 detects the execution of the destination content from the content distribution section 23 and counts the number of execution times of the day or the previous execution state evaluation period. FIG. 12 is a table showing an example of an execution state according to the present invention. In this example, points corresponding to the number of execution times of the day are given at first. The previous execution state evaluation period is one week as described above and is classified into entire day, weekday, midnight. Points corresponding to the number of execution times of the previous one week counted for each classification are given.

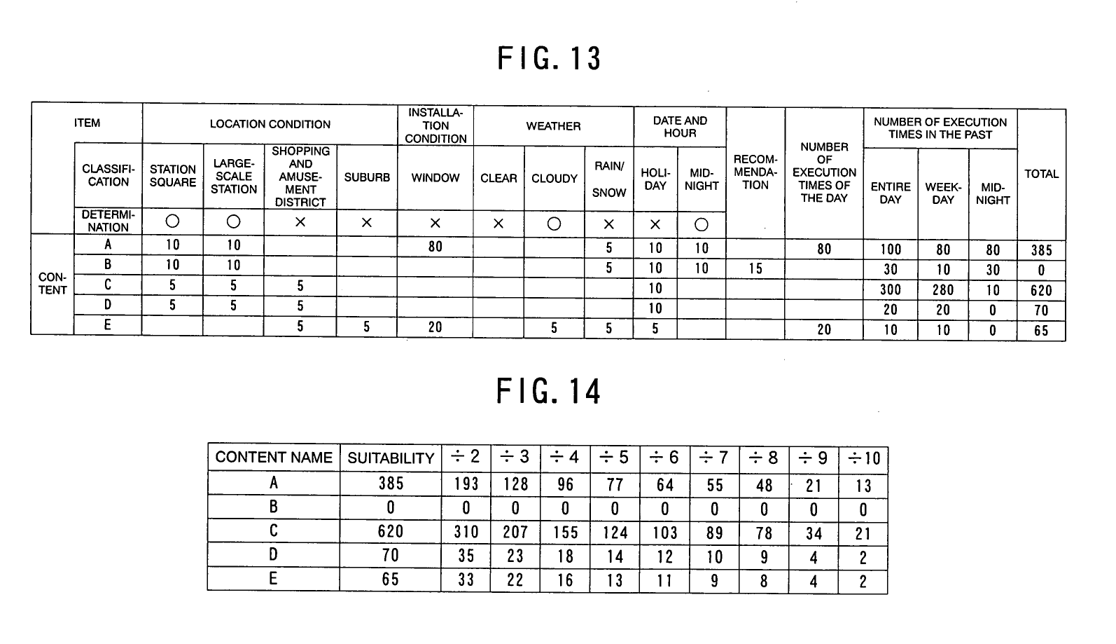

Next, a description will be given of a suitability calculation process. At first, the content suitability calculation section 21 creates a suitability calculation table for each client group. FIG. 13 is an example of the suitability calculation table according to the present invention. Firstly, the content suitability calculation section 21 inputs a point for each content to the suitability calculation table according to the scoring setting for location condition, installation condition, weather, date and hour and the content setting. Secondly, the content suitability calculation section 21 inputs a point for each content to the suitability calculation table according to the scoring setting determined by recommendation and the content setting. Thirdly, the content suitability calculation section 21 inputs a point for each content to the suitability calculation table according to the scoring setting determined by the execution state. Finally, the content suitability calculation section 21 adds up points for each content. The obtained point is the suitability of each content. The suitability of each content that has been calculated by the suitability calculation table of each client group is output to the content order determination section 22.

Next, a description will be given of a content order determination process. The content order determination section 22 determines the content order, which is the execution order of the promotion content, based on the content suitability for each client group. As a method for determining the content order, d'Hondt system used for proportional representation is used. FIG. 14 is an example of the content order determination table according to the present invention. In this example, input to the content order determination table are suitability (for each content that has been obtained in the table shown in FIG. 13), suitability/2, suitability/3, suitability/4, suitability/5, suitability/6, suitability/7, suitability/8, suitability/9, and suitability/10. By placing the order on all the values in the content order determination table, the order of the corresponding content is determined as the content order. When the order is placed on the values in the content order determination table in this example and sorting is made in descending order, the order of 620, 385, 310, 207, 193, is obtained, so that the content order of C, A, C, C, A, C, A, C, C, A, C, C is determined.

Here, the content order is determined by using all the contents. Alternatively, however, the content order is determined by using part of the contents. For example, the content order only for child is determined to be C, C, C, C, C, C, C, C, D, D, C, D.

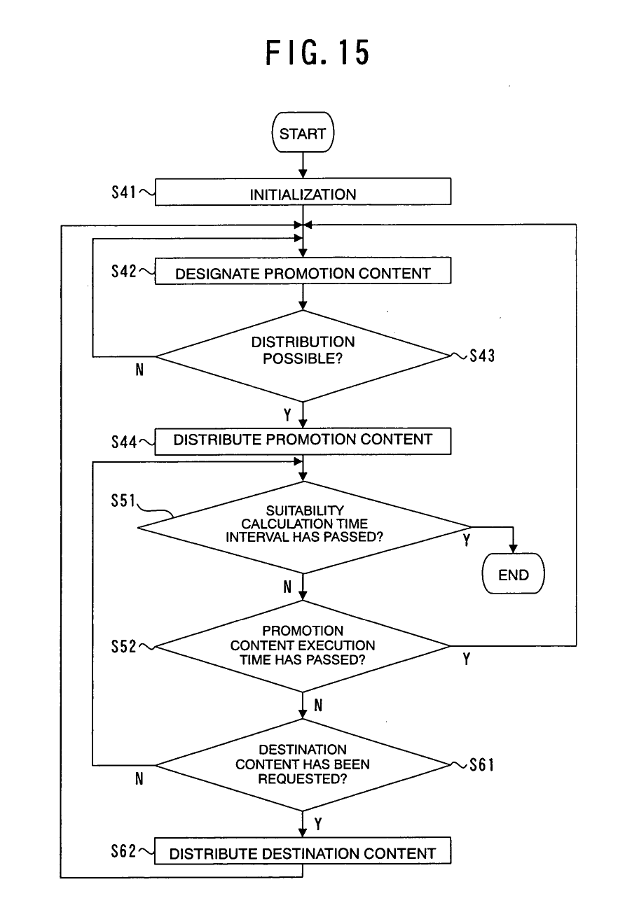

Next, a description will be given of a content distribution process. FIG. 15 is a flowchart showing an example of the content distribution operation according to the present invention. Firstly, as an initialization process, the “executed” flag for each content is set Off (S41). Secondly, the content distribution section 23 designates promotion content according to the content order in the group to which the designated client belongs (S42). Thirdly, the content distribution section 23 determines whether it is possible or not to distribute the designated promotion content (S43). When user profile flag is On, the content distribution section 23 checks the user profile. In the case where authentication such as age has not been completed, the content distribution section 23 precludes the distribution of the corresponding promotion content. Further, when multiple execution permission flag is Off and “executed” flag is On, the content distribution section 23 precludes the distribution of the corresponding promotion content.

When having precluded the distribution of the corresponding promotion content (No in S43), the content distribution section 23 designates the next promotion content according to the content order; on the other hand, when not having precluded the distribution (Yes in S43), the content distribution section 23 distributes the promotion content that has previously been stored in the content storage section 24 to the designated client group (S44).

Next, the content distribution section 23 determines whether content order determination time interval has passed or not (S51). When having determined that content order determination time interval has passed (Yes in S51), the content distribution section 23 ends this flow; on the other hand, when having determined that content order determination time interval has not passed (No in S51), the content distribution section 23 then determines whether promotion content execution time has passed or not (S52).

When having determined that promotion content execution time has passed (Yes in S52), the content distribution section 23 returns to step S42 and designates the next promotion content according to the content order; on the other hand, when having determined that promotion content execution time has not passed (No in S52), the content distribution section 23 then determines whether the client 2 has requested the destination content (S61).

When having determined that the client 2 has not requested the destination content (No in S61), the content distribution section 23 returns to step S51; on the other hand, when having determined that the client 2 has requested the destination content (Yes in S61), the content distribution section 23 then distributes (S62) the destination content that has previously been stored in the content storage section 24 and returns to step S42, where the content distribution section 23 designates the next promotion content according to the content order. When the destination content has been distributed, “executed” flag corresponding to the distributed flag is set On. Further, when execution state scoring flag is On, the execution state acquisition section 13 counts the number of execution times of the executed destination content.

The content distribution server 1 performs the above content distribution operation for each client group.

The operation as described above allows each client group to execute suitable promotion content, thereby prompting the user to execute the corresponding destination content.

In the above embodiment, promotion content is firstly distributed from the content distribution server 1 to the client 2, and when a request for corresponding destination content is issued from the user while the promotion content is being executed in the client 2, the destination content is distributed from the content distribution server 1 to the client 2 and executed in the client 2. Alternatively, however, content including promotion content and destination content may be distributed from the content distribution server 1 in place of the promotion content. In this case, when the content including promotion content and destination content is executed, the promotion content is firstly executed, and when a request for corresponding destination content is issued from the user while the promotion content is being executed, the destination content is executed in the client 2 without involving the distribution operation.

Although the content storage section 24 is included in the content distribution server 1 in the above embodiment, it may be included in an external server.

Further, a program that allows a computer constituting the content distribution server to execute the above steps can be provided as a content distribution program. When the program is stored in a computer-readable storage medium, the computer constituting the content distribution server can execute the program. The computer-readable medium mentioned here includes: portable storage medium such as a CD-ROM, a flexible disk, a DVD disk, a magneto-optical disk, an IC card; a database that holds a computer program; other computers and their databases; and a transmission medium on a communication line.

The state acquisition section corresponds to the setting management section, client state acquisition section, and content execution state acquisition section. The first data (content) corresponds to the destination content. The second data (content) corresponds to the promotion content.

What is claimed is:

1. A distribution device which distributes, to a device, second data for prompting a user to execute first data comprising:
a state acquisition section that acquires the states of the device and first data;
a suitability calculation section that calculates the suitability of the first data in the device based on the states of the device and first data that have been acquired by the state acquisition section;
an order determination section that determines the order of the second data based on the suitability that has been calculated by the suitability calculation section; and
a distribution section that distributes the second data to the device according to the order of the second data that has been determined by the order determination section.

2. The distribution device according to claim 1, wherein
the suitability calculation section has a predetermined scoring setting related to the states of the device and first data and calculates the suitability of the first data based on the predetermined scoring setting.

3. The distribution device according to claim 1, wherein
the order determination section determines the order of the second data according to d'Hondt system using the suitability.

4. The distribution device according to claim 1, wherein
the state of the device includes any of information related to location condition of the device, weather, and date and hour.

5. The distribution device according to claim 1, wherein
the state of the first data includes any of information related to target user of the first data, recommendation of the first data, and execution state of the first data.

6. A distribution method for distributing, to a device, second data for prompting a user to execute first data comprising:
acquiring the states of the device and first data;
calculating the suitability of the first data in the device based on the acquired states of the device and first data by the state acquisition step;
determining the order of the second data based on the calculated suitability by the suitability calculation step; and
distributing the second data to the device according to the determined order of the second data by the order determination step.

7. The distribution method according to claim 6, wherein
the suitability calculation step has a predetermined scoring setting related to the states of the device and first data and calculates the suitability of the first data based on the predetermined scoring setting.

8. The distribution method according to claim 6, wherein
the order determination step determines the order of the second data according to d'Hondt system using the suitability.

9. The distribution method according to claim 6, wherein
the state of the device includes any of information related to location condition of the device, weather, and date and hour.

10. The distribution method according to claim 6, wherein
the state of the first data includes any of information related to target user of the first data, recommendation of the first data, and execution state of the first data.

11. A distribution program which allows a computer to execute a distribution method for distributing, to a device, second data for prompting a user to execute first data comprising:
acquiring the states of the device and first data;
calculating the suitability of the first data in the device based on the acquired states of the device and first data by the states acquisition step;
determining the order of the second data based on the calculated suitability by the suitability calculation step; and
distributing the second data to the device according to the determined order by the order determination step.

12. The distribution program according to claim 11, wherein
the suitability calculation step has a predetermined scoring setting related to the states of the device and first data and calculates the suitability of the first data based on the predetermined scoring setting.

13. The distribution program according to claim 11, wherein
the order determination step determines the order of the second data according to d'Hondt system using the suitability.

14. The distribution program according to claim 11, wherein
the state of the device includes any of information related to location condition of the device, weather, and date and hour.

15. The distribution program according to claim 11, wherein
the state of the first data includes any of information related to target user of the first data, recommendation of the first data, and execution state of the first data.
